(19) United States
(12) Patent Application Publication
(10) Pub. No.: US 2006/0126563 A1
(43) Pub. Date: Jun. 15, 2006

(54) System and method of processing hand-off of mobile terminal

(76) Inventors: Sungsoo Kang, Daejeon-city (KR); Young Sik Park, Daejeon-city (KR); Sang Kwon Kim, Daejeon-city (KR); Hae Sook Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/127,690

(22) Filed: May 11, 2005

(30) Foreign Application Priority Data
Dec. 14, 2004 (KR) 10-2004-0105422
Mar. 9, 2005 (KR) 10-2005-0019583

(51) Int. Cl. H04Q 7/00

(52) U.S. Cl. 370/331

(57) ABSTRACT

Provided are a system and method of facilitating broadband data transmission by easily and quickly processing a hand-off of a mobile terminal using a high-altitude aeronautical platform above base stations. The system includes a hand-off related information transmitting/receiving unit informed by one of a plurality of base stations in a mobile communications network of a hand-off probability of the mobile terminal positioned in a cell that the base station covers; a position determining unit informed by the hand-off related information transmitting/receiving unit of the hand-off probability and determining whether the mobile terminal is positioned in an overlapping area between the cell that the base station covers and a cell that another base station covers; and a multicasting unit multicasting Internet packet data in a backbone network to the base station and the another base station when the mobile terminal is in the overlapping area via the hand-off related information transmitting/receiving unit.

This application claims the priority of Korean Patent Application Nos. 10-2004-0105422, filed on Dec. 14, 2004, and 10-2005-0019583, filed on Mar. 9, 2005, in the Korean Intellectual Property Office, the disclosures of which are incorporated herein in their entirety by reference.

### BACKGROUND OF THE INVENTION

1. Field of the Invention

The present invention relates to a system and method of processing a hand-off of a mobile terminal, and more particularly, to a hand-off processing system and method that facilitates broadband data transmission between mobile terminals, and even more particularly, to a system and method of facilitating broadband data transmission by easily and quickly processing a hand-off of a mobile terminal, which is moving at high speed, using a high-altitude aeronautical platform above base stations, for example, in the stratosphere.

2. Description of the Related Art

In a conventional code division multiple access (CDMA)-based mobile phone service, a soft hand-off mechanism is used to provide seamless service to mobile terminals. However, in the conventional soft hand-off mechanism, in the case of providing an Internet packet (IP) service to a mobile terminal, data is broadcast not only to a cell in which the mobile terminal is positioned but also to its neighboring cells, thereby wasting a lot of resources. In addition, since it is required to modify position information of the mobile terminal before transmitting an IP packet to the mobile terminal, the delivery of the IP packet is delayed too long. Such problems may limit broadband data service.

To solve these problems, U.S. Patent Publication No. 2001/0036834 discloses a method of enhancing the speed of hand-off processing by multicasting data, which includes a packet to transmit, for a predetermined period of time before modifying position information of a terminal between a cell in which the terminal is positioned, when the hand-off processing is required, and its neighboring cells. However, since a control signal for the hand-off processing is included in the data to transmit, the method is not appropriate for high-speed broadband multimedia service.

A wireless communication method using high-altitude aeronautical platforms in the stratosphere is suggested in “Stratospheric Quasi-stationary Platforms: (SQ-SP) Complementary to Radio Satellite Systems,” Electrical and Electronics Engineers in Israel, 1996, pp 283-286, November 1996. The method focuses on required power and coverage area for each frequency.

U.S. Pat. No. 6,167,263 (patented on Dec. 26, 2000) discloses a plurality of high-altitude aeronautical platforms for forming a communications network in the stratosphere. The focus in this disclosure is not on a specific communications method but on the structure and position control of the high-altitude aeronautical platforms needed to form the communications network in the stratosphere. Therefore, another method is required to provide broadband multimedia data to a terminal moving at high speed.

### SUMMARY OF THE INVENTION

According to an aspect of the present invention, there is provided a system for processing a hand-off of a mobile terminal, the system including: a hand-off related information transmitting/receiving unit informed by one of a plurality of base stations in a mobile communications network of a hand-off probability of the mobile terminal positioned in a cell that the base station covers; a position determining unit informed by the hand-off related information transmitting/receiving unit of the hand-off probability and determining whether the mobile terminal is positioned in an overlapping area between the cell that the base station covers and a cell that another base station covers; and a multicasting unit multicasting Internet packet data in a backbone network to the base station and the another base station when the mobile terminal is in the overlapping area via the hand-off related information transmitting/receiving unit. The hand-off related information transmitting/receiving unit is included in a high-altitude aeronautical platform such that data transmission through the mobile terminal and hand-off processing of the mobile terminal are carried out in a distributed manner.

The system further includes a data selection determining unit determining whether the mobile terminal selected one of the Internet packet data in the backbone network, which was multicast to the base station and the another base station, when the mobile terminal is in the overlapping area.

According to another aspect of the present invention, there is provided a method of processing a hand-off of a mobile terminal, the method including: (a) being informed by one of a plurality of base stations in a mobile communications network of a hand-off probability of the mobile terminal positioned in a cell that the base station covers, via a hand-off related information transmitting/receiving module included in a high-altitude aeronautical platform; (b) being informed of the hand-off probability and determining whether the mobile terminal is positioned in an overlapping area between the cell that the base station covers and a cell that another base station covers; and (c) multicasting Internet packet data in a backbone network to the base station and the another base station when the mobile terminal is in the overlapping area.

The method further includes (d) determining whether the mobile terminal selected one of the Internet packet data in the backbone network, which was multicast to the base station and the another base station.

### BRIEF DESCRIPTION OF THE DRAWINGS

The above and other features and advantages of the present invention will become more apparent by describing in detail exemplary embodiments thereof with reference to the attached drawings in which:

FIG. 1A is a schematic configuration illustrating a system of processing a hand-off of a mobile terminal according to the present invention;

FIG. 1B is a detailed configuration of the system of processing a hand-off of a mobile terminal illustrated in FIG. 1A; and

FIG. 2 is a flowchart illustrating a method of processing a hand-off of a mobile terminal according to an embodiment of the present invention.

### DETAILED DESCRIPTION OF THE INVENTION

To facilitate the understanding of the present invention, the core of the technical spirit of the present invention will be now explained.

According to “Establishing Wireless Communications Service via High-altitude Aeronautical Platforms: A Concept Whose Time Has Come?,” IEEE Comm. Magazine, Vol. 35, Issue 9, pp 128-135, September 1997 and “The Future Generation of Mobile Communications Based on Broadband Access Technologies,” IEEE Comm. Magazine, Vol. 38, Issue 12, pp 134-142, December 2000, when high-altitude aeronautical platforms deployed in the stratosphere are used for communications, since the high-altitude aeronautical platforms are at an altitude of 50 km or less, information transmission delay is short. In addition, since a frequency band far higher than a frequency band of 2 GHz for general mobile communications can be used, broadband information transmission is possible.

In the present invention, such high-altitude aeronautical platforms are used for communications. Therefore, transmission of broadband multimedia data, such as moving images, is made using a conventional mobile communications network (base station). Further, a base station and a high-altitude aeronautical platform (HAAP) including a hand-off processing module process a hand-off of a mobile terminal, which occurs when the mobile terminal moves from a cell to its neighboring cell. Therefore, high-speed mobility of a broadband data terminal can be more easily and quickly processed.

The present invention will now be described more fully with reference to the accompanying drawings, in which exemplary embodiments of the invention are shown. The invention may, however, be embodied in many different forms and should not be construed as being limited to the embodiments set forth therein; rather, these embodiments are provided so that this disclosure will be thorough and complete, and will fully convey the concept of the invention to those skilled in the art. Like reference numerals in the drawings denote like elements, and thus their description will omitted.

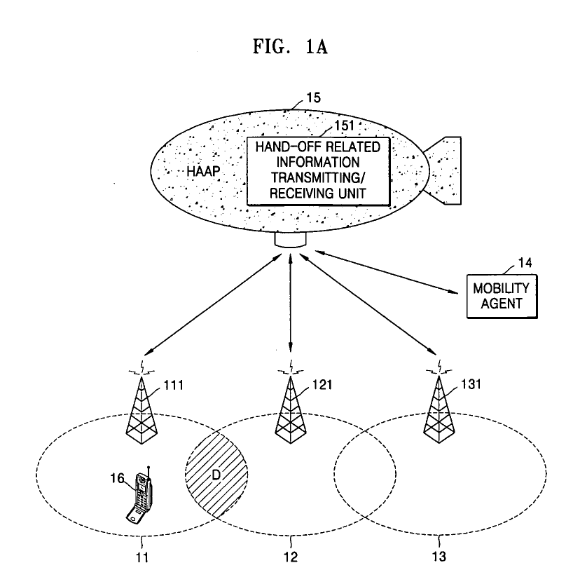

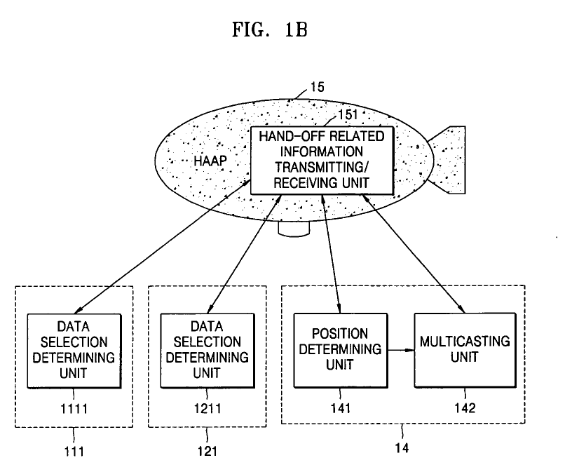

FIG. 1A is a schematic configuration illustrating a system of processing a hand-off of a mobile terminal according to the present invention. When a mobile terminal 16 enters a cell 11 that a base station 111 covers, the base station 111 mediates data transmission of the mobile terminal 16 with terminals within the cell 11. Similarly, base stations 121 and 131 mediate data transmission between a mobile terminal, which enters cells 12 and 13 that the base stations 121 and 131 respectively cover, and terminals within their respective cells 12 and 13.

A mobility agent 14 manages the mobility of the mobile terminal 16 when the mobile terminal 16 is moving from a cell to its adjacent (neighboring) cell, that is, when the mobile terminal 16 is positioned in an overlapping area D between the cells 11 and 12 or in an overlapping area between the cells 12 and 13. In other words, the mobility agent 14 determines whether the mobile terminal 16 selects IP data transmitted from the base station 111 or IP data transmitted from the base station 121 and manages information regarding the selection by the mobile terminal 16.

A hand-off related information transmitting/receiving unit 151 is included in a HAAP 15 in the stratosphere 15 km or less above the earth. The hand-off related information transmitting/receiving unit 151 collects information regarding the mobility of the mobile terminal, i.e., hand-off related information, from the mobility agent 14 and the base stations 11, 12 and 13, and mediates the exchange of the information among the mobility agent 14 and the base stations 11, 12 and 13.

The transmission of data, which generally contains voice, between the mobile terminal 16 and a caller that calls the mobile terminal 16 is made using the base stations 111, 121 and 131. Communications between the caller and the base stations 111, 121 and 131, or between the base stations 111, 121 and 131 are made using a backbone network.

If the mobile terminal 16 is in the cell 1 1 that the base station 1 1 1 covers and not in the overlapping area D between the cells 11 and 12, data of the caller connected to the mobile terminal 16 is unicast via the base station 111.

However, if the mobile terminal moves to the overlapping area D, the base station of the cell 12 senses the movement of the mobile terminal 16, that is, senses a hand-off probability, and informs the hand-off related information transmitting/receiving unit 151 included in the HAAP 15 of the movement. Then, the hand-off related information transmitting/receiving unit 151 informs the mobility agent 14 of the movement of the mobile terminal 16.

Informed by the hand-off related information transmitting/receiving unit 151 of the movement of the mobile terminal 16, the mobility agent 14 multicasts IP data (user data, not data for managing mobility of a mobile terminal) in a backbone network to the base stations 111 and 121, which cover the overlapping area D, via the hand-off related information transmitting/receiving unit 151.

From the multi-cast data to the base stations 111 and 121, if the mobile terminal 16 selects data transmitted from the base station 121, the base station 121 immediately informs the mobility agent 14 that the mobile terminal 16 selected the data of the base station 121, via the hand-off related information transmitting/receiving unit 151.

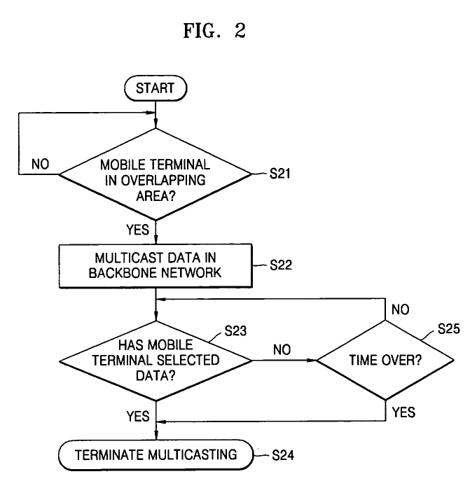

FIG. 1B is a detailed configuration of the system of processing a hand-off of a mobile terminal illustrated in FIG. 1A. FIG. 2 is a flowchart illustrating a method of processing a hand-off of the mobile terminal 16 according to an embodiment of the present invention.

A position determining unit 141 included in the mobility agent 14 is informed by the hand-off related information transmitting/receiving unit 151 of the hand-off probability of the mobile terminal 16 and determines whether the mobile terminal 16 is in the overlapping area D (S21). For example, the position determining unit 141 determines whether the mobile terminal 16 is in the overlapping area D between the cell 11 that the base station 111 covers and the cell 12 that the base station 121 covers.

When informed by the position determining unit 141 that the mobile terminal 16 is in the overlapping area D, a multicasting unit 142 included in the mobility agent 14 transmits data in the backbone network to the hand-off related information transmitting/receiving unit 151 to multicast the data to the base stations 111 and 121 (S22).

Data selection determining units 1111 and 1211 respectively included in the base stations 111 and 121 determine whether the mobile terminal 16 selected one of the data multicast to the base stations 111 and 121 (S23) and inform the hand-off related information transmitting/receiving unit 151 of the result of determination. In other words, the data selection determining units 1111 and 1211 determine whether the mobile terminal 16 decided to transmit/receive data through a specific base station (the base station 111 or 121 in the present embodiment).

When informed by the data selection determining units 1111 and 1211 that the mobile terminal 16 selected the base station 111 or 121 to transmit/receive data, via the hand-off related information transmitting/receiving unit 151, the multicasting unit 142 terminates multicasting the IP data in the backbone network (S24).

Since the mobile terminal 16 selected the base station 111 or 121 to transmit/receive data, multicasting ends and unicasting starts. In other words, even through the mobile terminal 16 is in the overlapping area D, since the mobile terminal 16 decided to receive the data in the backbone network of the base station 121, the base station 111 no longer transmits data to the mobile terminal 16.

If the mobile terminal 16 did not decide to transmit/receive data from the base station 121 or 111, the multicasting unit 142 determines whether the state of ‘no selection’ last longer than a set period of time (whether the time for decision is over) (S25) and determines whether to terminate multicasting. If the state of ‘indecision’ did not last longer than the set period of time, the data selection determining units 1111 and 1211 determine again whether the mobile terminal 16 selected the base station 111 or 121 to transmit/receive data. If the state of ‘no selection’ last longer than the set period of time, the multicasting unit 142 terminates multicasting the data in the backbone network (S25).

The set period of time is required to allow other terminals to use IP data when the mobile terminal 16 does not transmit the IP data for a long period of time in order to enhance efficiency of resource use.

As described above, data is multicast, not to all base stations (network), but only to the base stations 111 and 121 that respectively cover the cells 1 1 and 12 having the overlapping area D until the mobile terminal 16 ‘selects’ the base station 111 or 121 to transmit/receive data. Thus, limited resources can be efficiently used.

In addition, information needed to process hand-offs between the base station 111 or 121 and the mobility agent 14 is processed by the hand-off related information transmitting/receiving unit 151, apart from a conventional data transmission network. In other words, since data transmission and hand-offs between terminals are processed in a distributed fashion, a terminal, which transmits broadband data increasingly being used, can receive seamless service even when moving at high speed.

According to the present invention, a base station transmits/receives broadband multimedia data, such as moving images, to/from a subscriber terminal moving at high speed. In addition, a hand-off related information transmitting/receiving unit included in a HAAP above the base station, for example, in the stratosphere, processes the hand-off of the subscriber terminal moving at high speed. As described above, since data transmission and hand-offs between terminals are processed in a distributed manner, the hand-offs can be processed more easily and quickly, which in turn facilitates the transmission of the broadband multimedia data.

The present invention can also be implemented as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet).

The computer-readable recording medium can also be distributed over network-coupled computer systems so that the computer-readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A system for processing a hand-off of a mobile terminal, the system comprising:
a hand-off related information transmitting/receiving unit informed by one of a plurality of base stations in a mobile communications network of a hand-off probability of the mobile terminal positioned in a cell that the base station covers;
a position determining unit informed by the hand-off related information transmitting/receiving unit of the hand-off probability and determining whether the mobile terminal is positioned in an overlapping area between the cell that the base station covers and a cell that another base station covers; and
a multicasting unit multicasting Internet packet data in a backbone network to the base station and the another base station when the mobile terminal is in the overlapping area via the hand-off related information transmitting/receiving unit,
wherein the hand-off related information transmitting/receiving unit is included in a high-altitude aeronautical platform such that data transmission through the mobile terminal and hand-off processing of the mobile terminal are carried out in a distributed manner.

2. The system of claim 1, further comprising a data selection determining unit determining whether the mobile terminal selected one of the Internet packet data in the backbone network, which was multicast to the base station and the another base station, when the mobile terminal is in the overlapping area.

3. The system of claim 2, wherein the multicasting unit terminates multicasting the Internet packet data when the multicasting unit is informed by the data selection determining unit that the mobile terminal selected one of the Internet packet data, via the hand-off related information transmitting/receiving unit, determines whether a state of ‘no selection’ last longer than a set period of time when the multicasting unit is informed of nothing since the mobile terminal did not select any of the Internet packet data, and terminates multicasting the Internet packet data when the state of ‘no selection’ last longer than the set period of time.

4. A method of processing a hand-off of a mobile terminal, the method comprising:
(a) being informed by one of a plurality of base stations in a mobile communications network of a hand-off probability of the mobile terminal positioned in a cell that the base station covers, via a hand-off related information transmitting/receiving module included in a high-altitude aeronautical platform;
(b) being informed of the hand-off probability and determining whether the mobile terminal is positioned in an overlapping area between the cell that the base station covers and a cell that another base station covers; and
(c) multicasting Internet packet data in a backbone network to the base station and the another base station when the mobile terminal is in the overlapping area, wherein data transmission through the mobile terminal and hand-off processing of the mobile terminal are carried out in a distributed manner.

5. The method of claim 4, further comprising (d) determining whether the mobile terminal selected one of the Internet packet data in the backbone network, which was multicast to the base station and the another base station.

6. The method of claim 5, further comprising:
(e) terminating multicasting the Internet packet data when informed that the mobile terminal selected one of the Internet packet data as a result of determination in operation (d);
(f) determining whether a state of ‘no selection’ last longer than a set period of time when informed of nothing since the mobile terminal did not select any of the Internet packet data; and
(g) terminating multicasting the Internet packet data when the state of ‘no selection’ last longer than the set period of time and returning to operation (d) when the state of ‘no selection’ did not last longer than the set period of time.
